(19) United States
(12) Patent Application Publication
(10) Pub. No.: US 2018/0082277 A1
(43) Pub. Date: Mar. 22, 2018

(54) SYSTEMS AND METHODS FOR ALLOCATING TRANSACTIONS

(71) Applicant: Capital One Services, LLC, McLean, VA (US)

(72) Inventors: Emma SAGAN, Washington, DC (US); Cameron SMITH, Washington, DC (US); Ashley REPHLO, Arlington, VA (US); Allison ABBOTT, Washington, DC (US); Jonathan TURFBOER, San Francisco, CA (US); Jeremy REPHLO, Arlington, VA (US)

(73) Assignee: Capital One Services, LLC, McLean, VA (US)

(21) Appl. No.: 15/824,971

(22) Filed: Nov. 28, 2017

Related U.S. Application Data
(63) Continuation of application No. 15/085,606, filed on Mar. 30, 2016.
(60) Provisional application No. 62/140,899, filed on Mar. 31, 2015.

(51) Int. Cl. G06Q 20/22; G06Q 20/10

(52) U.S. Cl. CPC G06Q 20/227; G06Q 20/102; G06Q 20/10

(57) ABSTRACT

A system and method are provided for allocating a transaction among a plurality of accounts. The system comprises one or more memory devices storing instructions and one ore more data records associating a transaction rule with a first account, and one or more processors configured to execute the instructions to receive transaction information corresponding to a transaction associated with the first account. The transaction information includes a transaction amount. A processor is also configured to authorize the transaction based on account information of the first account and determine that the transaction information corresponds to a transaction rule associated with the first account, wherein the transaction rule includes allocation information and information identifying a second account. Additionally, the processor is configured to allocate at least a part of the transaction amount to the second account based on the allocation information according to the transaction rule.

### PRIORITY CLAIM

This application claims priority under 35 U.S.C. § 119 to U.S. provisional patent application no. 62/140,899, filed on Mar. 31, 2015, titled “Systems and Methods for Allocating Transaction Responsibility Between Multiple Accounts.” The aforementioned application is incorporated herein by reference in its entirety.

### BACKGROUND

Current financial service accounts and payment/purchase transaction systems do not implement effective processes or systems for sharing a transaction between separate accounts. For example, under current systems, a purchaser making a single transaction using a payment method associated with a financial service account is unable to effectively split the liability and rewards (or other incentives) resulting from the transaction. Using current methods and systems, a transacting user wishing to split the cost of a shared expense with a partner, roommate, or other entity must generally request repayment from the other entities for some desired amount. Repayment may be in the form of cash, check or other electronic transfer. These repayment methods, however, suffer many drawbacks.

One such drawback is the inability to immediately receive repayment. The transacting user may be at the mercy of the other party to receive payment, which may not be received before the liability is owed. Additionally, receiving repayment in the form of a check or cash or even an electronic transfer creates a burden on the transacting party to allocate the received funds to the appropriate transaction and may create other inconveniences generally associated with cashing a check or depositing cash.

Other disadvantages arise to the non-transacting user, who although he contributes to the amount of a purchase or payment, does not enjoy the rewards or other incentives offered by financial service providers for using a particular financial service account in the payment transaction. These lost rewards may be significant over time considering the accumulation of frequent transactions, such as monthly rent and utility expenses.

Some financial service providers enable one or more users to participate in a joint account as joint account holders or authorized users. Such accounts, however, are incapable of allocating liability of a transaction to only one of the joint account holders. As such, these accounts may be susceptible to abusive or fraudulent behavior. But many joint account holders may desire to share the liability of certain transactions entered into by one of the account holders without incurring the risk of inappropriate use of the account. Additionally, these accounts lack other advantages attendant with management of a single account, such as a sense of responsibility or privacy.

Thus, there is a need for improved methods and systems to enable allocation of liability and other incentives or rewards for a single transaction among multiple separate accounts.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The present disclosure provides systems and methods for allocating a transaction among separate financial service accounts without additional involvement from a merchant or service provider apart from the transaction itself. The transaction may initially be processed at a merchant or service provider according to a conventional transaction process. In some embodiments, however, the disclosed systems and methods enable one or more entities to share the liability and/or incentives of the transaction after the initial transaction is processed at the merchant. Additional aspects of the disclosed embodiments are set forth below in this disclosure.

The disclosed embodiments include a system provided for allocating a transaction among a plurality of accounts. The system comprises one or more memory devices storing instructions and one or more data records associating a transaction rule with a first account, and one or more processors configured to execute the instructions to receive transaction information corresponding to a transaction associated with the first account. The transaction information includes a transaction amount. A processor is also configured to authorize the transaction based on account information of the first account and determine that the transaction information corresponds to a transaction rule associated with the first account, wherein the transaction rule includes allocation information and information identifying a second account. Additionally, the processor is configured to allocate at least a part of the transaction amount to the second account based on the allocation information according to the transaction rule.

The disclosed embodiments include a computer readable medium storing instructions executable by a processor to cause the processor to perform a method including receiving transaction information corresponding to a transaction associated with a first account. The transaction information includes a transaction amount. The method also includes authorizing the transaction based on account information of the first account and determining whether the transaction information corresponds to a transaction rule associated with the first account, wherein the transaction rule includes allocation information and information identifying a second account. Additionally, the method allocates at least a part of the transaction amount to the second account according to the allocation information of the transaction rule.

The disclosed embodiments also include a method for allocating a transaction among a plurality of accounts. The method includes receiving transaction information corresponding to a transaction associated with a first account, the transaction information including a transaction amount. The method also determines a transaction rule corresponding to the transaction information, the transaction rule being associated with the first account and including allocation information and information identifying a second account, and authorizes the transaction based on the transaction rule as applied to the first and second accounts. The method further includes allocating at least a part of the transaction amount to the second account according to the allocation information of the transaction rule.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system, consistent with the disclosed embodiments;

FIG. 2 is a block diagram of an exemplary computer system, consistent with the disclosed embodiments;

FIG. 3 is a flowchart of an exemplary registration process for registering a transaction rule, consistent with the disclosed embodiments;

FIG. 4 is a table of an exemplary data record for associating a transaction rule with a customer account, consistent with the disclosed embodiments;

FIG. 5 is a flowchart of an exemplary allocation process for allocating a transaction with multiple accounts, consistent with the disclosed embodiments;

FIG. 6 is a flowchart of an exemplary allocation process for allocating a transaction with multiple accounts, consistent with the disclosed embodiments;

FIG. 7 is a flowchart of an exemplary allocation request process for requesting allocation of a transaction with multiple accounts, consistent with the disclosed embodiments;

FIG. 8 is a flowchart of an exemplary confirmation process for confirming allocation of a transaction with multiple accounts, consistent with the disclosed embodiments;

FIG. 9 is a flowchart of an exemplary allocation process for allocating a transaction with multiple accounts, consistent with the disclosed embodiments;

FIG. 10 is a flowchart of an exemplary transaction process for allocating a transaction with multiple accounts, consistent with the disclosed embodiments;

FIG. 11 is an example of a user device interface enabling registration of a transaction rule, consistent with the disclosed embodiments;

FIG. 12 is an example of a user device interface enabling selection of a recent transaction for allocation, consistent with the disclosed embodiments; and

FIG. 13 is an example of a user device interface enabling a transaction allocation request, consistent with the disclosed embodiments.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

The present disclosure describes an advantageous transaction allocation system and method for allocating a transaction among separate entities or accounts apart or distinct from the transaction itself. For example, the disclosed embodiments provide computing systems and methods to enable one or more entities to share the liability and/or incentives of a transaction without involvement from the merchant or service provider that processed the initial transaction. The disclosed embodiments may generally be categorized according to a proactive embodiment and a retroactive embodiment, or some combination of both.

In a proactive embodiment, a data record may be implemented to associate a customer account of a financial service provider with one or more transaction rules specifying when and how certain transactions may be allocated or shared with another entity or another account. According to some embodiments, a financial service provider processing a transaction may determine whether the transaction corresponds to any of the defined transaction rules, and allocate liability and/or incentives of the transaction with one or more other entities or accounts according to the transaction rules. The one or more entities may define the transaction rules in advance.

In a retroactive embodiment, an interface or other system and method may be provided for enabling a user to allocate or share a transaction with one or more entities without predefining a transaction rule associated with a financial service account. According to some embodiments, following a purchase transaction, the entity that performed the transaction may select a transaction from transaction history displayed on an interface, for example, and designate the transaction to be allocated or shared with a second account or entity who may have the opportunity to confirm the allocation. The financial service provider may then allocate the liability and/or incentives of the transaction with the second account according to the confirmed request.

The disclosed systems and methods may be advantageous for many different situations and relationships among one or more entities. In some embodiments, the separate entities may include two or more individuals in a financial support relationship, such as a parent and child, a caretaker and dependent, roommates, spouses or any other type of relationship where it may be beneficial to allocate the liability for particular common or frequent transactions. For example, for a parent-child relationship, the disclosed embodiments may enable the parent and child to autonomously own separate financial service accounts, but enable the parent to automatically share the liability of certain predefined transactions entered into by the child such as for payment of textbooks or medical expenses or any other myriad transactions. In this example, the parent's liability may be limited to only certain transactions and certain transaction amounts, thus shielding the parent from general liability that arises when a parent co-signs on their child's account. As another example, roommates may be able to automatically share the liability of certain common transactions related to payment of rent or utilities.

The disclosed systems may also be advantageous for entities to share uncommon purchase transactions such as a one-time purchase of furniture, for example. The disclosed systems and embodiments may also be beneficial in social settings to enable friends or co-workers to share the cost of a meal out at a restaurant or for any other purchase that may not be shared or split during the purchase transaction at the merchant or service provider.

The disclosed embodiments provide numerous advantages other than the allocation of liability or the sharing of cost of particular transactions that may not be realized by conventional systems. For example, the disclosed embodiments enable the allocation of a transaction between separate entities autonomously owning individual financial service accounts. Thus, the disclosed embodiments combine the certain benefits of efficient allocation of a transaction with the advantages of separately owned and managed individual financial service accounts. Some of these benefits include the ability of separate account holders to generate individual credit history, instill responsibility and autonomy in managing an individual account, and prevent certain abuses or fraudulent behavior that may result from shared access to an account.

The disclosed embodiments may also be beneficial to a single entity that may wish to allocate a transaction among various accounts managed and controlled by the entity. For example, the disclosed embodiments enable a user to allocate a single transaction executed using a single credit card among a plurality of other accounts. Such an embodiment may be beneficial to a user making a transaction using a corporate account where only transactions of a certain dollar amount, or with a certain merchant, may be made. According to some embodiments, any single transaction can be applied to the corporate account up to a defined limit amount and the remainder can be applied to a personal account. Many other scenarios are also envisioned. The disclosed embodiments may be advantageous by permitting a user to allocate certain transactions among a personal account and a business account, while using a single form of payment for the various transactions.

Additionally, the disclosed systems and methods enable one or more entities to enjoy the benefits of certain incentives of a financial service account, such as cash back or other rewards, when they share in the liability of a transaction. For example, the disclosed systems and methods may prevent the inequity of conventional systems where a roommate may enjoy the reward benefits of paying for full rent or utilities using an individual account even though he only shares in a portion of the total expense. The disclosed systems and methods provide the ability to share not only the liability of the transaction but also any incentives realized in the transaction.

The following disclosure provides exemplary systems and methods for allocating the liability and/or incentives of a transaction capable of realizing the above advantages and benefits over conventional systems.

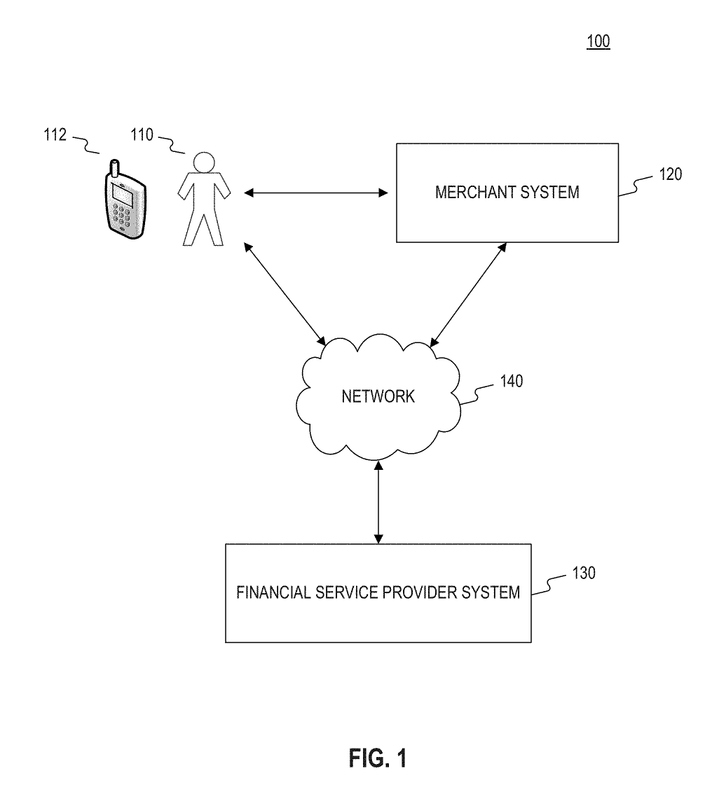

FIG. 1 shows a diagram of an exemplary transaction allocation system 100 that may be configured to allocate a transaction among a plurality of entities or accounts, consistent with disclosed embodiments.

As shown in FIG. 1, system 100 may include a user device 112 associated with a user 110, a merchant system 120, a financial service provider system 130, and a network 140 to facilitate communication among the components of system 100. The components and arrangement of the components included in system 100 may vary. Thus, system 100 may further include other components that perform or assist in the performance of one or more processes consistent with the disclosed embodiments. The components and arrangements shown in FIG. 1 are not intended to limit the disclosed embodiments, as the components used to implement the disclosed processes and features may vary.

In accordance with disclosed embodiments, a transaction allocation system 100 may include a financial service provider (FSP) system 130. FSP system 130 may be a system associated with a financial service provider (not shown), such as a bank, a credit card company, a lender, brokerage firm, or any other type of financial service entity that generates, provides, manages, and maintains financial service accounts for one or more users 110. FSP system 130 may include one or more computing systems that are configured to execute software instructions stored on one or more memory devices to perform one or more operations consistent with the disclosed embodiments. For example, FSP system 130 may include one or more memory device(s) storing data and software instructions and one or more processor(s) configured to use the data and execute the software instructions to perform server-based functions and operations known to those skilled in the art. FSP system 130 may include one or more general purpose computers, mainframe computers, or any combination of these types of components.

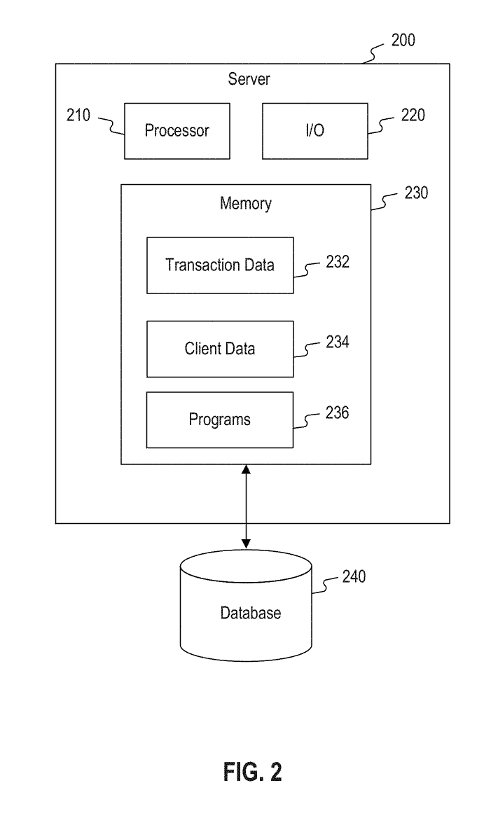

In certain embodiments, FSP system 130 may be configured as a particular apparatus, system, and the like, based on the storage, execution, and/or implementation of the software instructions that perform one or more operations consistent with the disclosed embodiments. FSP system 130 may be standalone, or it may be part of a subsystem, which may be part of a larger system. For example, FSP system 130 may represent distributed servers that are remotely located and communicate over a public network (e.g., network 140) or a dedicated network, such as a LAN, for a financial service provider. An exemplary computing system consistent with FSP system 130 is discussed in additional detail with respect to FIG. 2, below.

FSP system 130 may include or may access one or more storage devices configured to store data and/or software instructions used by one or more processors of FSP system 130 to perform operations consistent with disclosed embodiments. For example, FSP system 130 may include memory configured to store one or more software programs that perform several functions when executed by a processor including functions specific to the disclosed transaction allocation methods. The disclosed embodiments are not limited to separate programs or computers configured to perform dedicated tasks. For example, FSP system 130 may include memory that stores a single program or multiple programs. Additionally, FSP system 130 may execute one or more programs located remotely from FSP system 130. For example, FSP system 130 may access one or more remote programs stored in memory included with a remote component that, when executed, perform operations consistent with the disclosed embodiments. In certain aspects, FSP system 130 may include server software that generates, maintains, and provides services associated with processing financial transactions. In other aspects, FSP system 130 may connect with separate server(s) or similar computing devices that generate, maintain, and provide services associated with financial data for a financial service provider associated with FSP system 130.

System 100 may also include one or more merchant systems 120. Merchant system 120 may be a computing system that is associated with a merchant or other business entity that provides goods and/or services, such as a restaurant, retailer, grocery store, service provider (e.g., utilities, etc.), or any other type of entity that may engage in any financial transaction (e.g. charity, tax collector, etc.) or other commercial transaction with a consumer, including health care or other professionals and education providers. While system 100 is shown with one merchant system 120, the disclosed embodiments may be implemented in a system including two or more merchant systems 120 associated with any number of underlying entities (commercial or otherwise). Further, merchant system 120 is not limited to conducting business in any particular industry or field.

Merchant system 120 may be associated with a merchant brick and mortar location(s) that a user 110 may physically visit and purchase goods and services. Such physical locations may include computing devices that perform financial service transactions with consumers (e.g., Point of Sale (POS) terminal(s), kiosks, etc.). Merchant system 120 may also include back and/or front-end computing components that store data and execute software instructions to perform operations consistent with disclosed embodiments, such as computers that are operated by employees of the merchant (e.g., back office systems, etc.). Merchant system 120 may also be associated with a merchant that provides goods and/or services via known online or e-commerce types of solutions. For example, such a merchant may sell goods or otherwise accept payment via a website using known online or e-commerce systems and solutions to market, sell, and process online transactions.

In some embodiments, merchant system 120 may include one or more servers or other type of computer devices. The merchant system server(s) may be one or more computing devices configured to execute software instructions stored in memory to perform one or more processes consistent with the disclosed embodiments. For example, merchant system 120 may include one or more memory device(s) storing data and software instructions and one or more processor(s) configured to use the data and execute the software instructions to perform server-based functions and operations known to those skilled in the art.

Merchant system 120 may further include server(s) that are configured to execute stored software instructions to perform operations associated with a merchant, including one or more processes associated with processing purchase transactions, generating transaction data, and generating product data (e.g., SKU data) relating to purchase transactions, etc. Merchant system 120 may include one or more servers that may include a general purpose computer, a mainframe computer, or any combination of these components. In certain embodiments, merchant system 120 (or a system including merchant system 120) may be configured as a particular apparatus, system, and the like based on the storage, execution, and/or implementation of the software instructions that perform one or more operations consistent with the disclosed embodiments. A merchant server may be standalone, or it may be part of a subsystem, which may be part of a larger system. For example, a merchant server may represent distributed servers that are remotely located and communicate over a public network (e.g., network 140) or a dedicated network, such as a LAN. An exemplary computer system consistent with merchant system 120 is discussed in additional detail with respect to FIG. 2.

In certain aspects, merchant system 120 may include one or more web servers that execute software that generates, maintains, and provides web site(s) for a respective merchant that is accessible over network 140. In other aspects, a merchant system 120 may connect separately to web server(s) or similar computing devices that generate, maintain, and provide web site(s) for a merchant.

In certain embodiments, a merchant may operate components associated with merchant system 120 to perform one or more processes consistent with the disclosed embodiments. For example, merchant system 120 may be configured to execute software instructions to provide transaction data and/or product data and other data relating to purchase transactions to FSP system 130 over network 140.

System 100 may further include one or more user devices 112. A user 110 may operate a user device 112, which may be a desktop computer, laptop, tablet, smartphone, multifunctional watch, pair of multifunctional glasses, tracking device, or any suitable device with computing capability. User device 112 may have a financial application installed thereon, which may enable user device 112 to communicate with

FSP system 130 via network 140 and perform aspects of the disclosed transaction allocation methods. Alternatively, user device 112 may connect to FSP system 130 and/or merchant system 120 through use of browser software. User device 112 may allow a user to access information stored in FSP system 130, such as, for example, financial information related to recent purchase transactions, financial statements, account information, rewards program information and the like. User device 112 may also be configured to enter a purchase or payment transaction as a mobile payment device. An exemplary computer system consistent with user device 112 is discussed in additional detail with respect to FIG. 2.

User 110 may operate user device 112 to perform one or more operations for allocating a transaction consistent with the disclosed embodiments. In one aspect, user 110 may be a customer of a financial service provider associated with FSP system 130. For instance, a financial service provider may maintain a financial service account (e.g., credit card account, checking account, etc.) that the user may use in a transaction, such as, for example, a purchase of goods and/or services online or at brick and mortar locations associated with a merchant relating to merchant system 120. Consistent with disclosed embodiments, user 110 may operate user device 112 to initiate a purchase transaction with a merchant or merchant system 120, and execute the transaction allocation processes of the exemplary embodiments. Payment transaction initiated with user device 112 may include an e-commerce transaction or a mobile payment transaction. A purchase transaction may also be initiated with a merchant or merchant system 120 using any known method, such as presentation of a bank card or credit card, or the presentation of bank card or credit card information. Further, user 110 may operate user device 112 to view a financial service account or financial statement provided by a financial service provider or FSP system 130 and perform certain allocation methods enabled by the financial service account according to the disclosed embodiments.

Network 140 may comprise any type of computer networking arrangement used to exchange data. For example, network 140 may be the Internet, a private data network, a virtual private network using a public network, a Wi-Fi network, a LAN or WAN network, and/or other suitable connections that may enable information exchange among various components of system 100. Network 140 may also include a public switched telephone network (“PSTN”) and/or a wireless cellular network. Network 140 may be a secured network or unsecured network. In other embodiments, one or more components of system 100 may communicate directly through a dedicated communication link(s), such as links between FSP system 130 and merchant system 120.

Other components known to one of ordinary skill in the art may be included in system 100 to process, transmit, provide, and receive information consistent with the disclosed embodiments. In addition, although not shown in FIG. 1, components of system 100 may communicate with each other through direct communications, rather than through network 140. Direct communications may use any suitable technologies, including close range communication protocols, such as those employed under the name BLUETOOTH™ or BLUETOOTH LE™, and Wi-Fi, or any known near field communications (NFC) techniques, or other suitable communication methods that provide a medium for transmitting data between separate devices.

FIG. 2 shows a diagram of an exemplary computing system 200 illustrating a computing system configuration that may be associated with FSP system 130, merchant system 120, and/or user device 112, consistent with the disclosed embodiments.

In some embodiments, computing system 200 may include one or more processors 210, one or more memories 230, and one or more input/output (I/O) devices 220. In some embodiments, computing system 200 may take the form of a server, general purpose computer, a mainframe computer, laptop, smartphone, mobile device, or any combination of these components. In certain embodiments, computing system 200 (or a system including computing system 200) may be configured as a particular apparatus, system, and the like based on the storage, execution, and/or implementation of the software instructions that perform one or more operations consistent with the disclosed embodiments. Computing system 200 may be standalone, or it may be part of a subsystem, which may be part of a larger system.

Processor 210 may include one or more known processing devices, such as a microprocessor from the Pentium™ or Xeon™ family manufactured by Intel™, the Turion™ family manufactured by AMD™, or any of various processors manufactured by Sun Microsystems, for example. Processor 210 may constitute a single core or multiple core processor that executes parallel processes simultaneously. For example, processor 210 may be a single core processor configured with virtual processing technologies. In certain embodiments, processor 210 may use logical processors to simultaneously execute and control multiple processes. Processor 210 may implement virtual machine technologies, or other known technologies to provide the ability to execute, control, run, manipulate, store, etc. multiple software processes, applications, programs, etc. In another embodiment, processor 210 may include a multiple-core processor arrangement (e.g., dual, quad core, etc.) configured to provide parallel processing functionalities to allow computing system 200 to execute multiple processes simultaneously. One of ordinary skill in the art would understand that other types of processor arrangements could be implemented that provide for the capabilities disclosed herein. The disclosed embodiments are not limited to any type of processor(s) configured in computing system 200.

Memory 230 may include one or more storage devices configured to store instructions executable by processor 210 to perform functions related to the disclosed embodiments. For example, memory 230 may be configured with one or more software instructions, such as one or more program(s) 236 that perform particular functions when executed by processor 210. The disclosed embodiments are not limited to separate programs or computers configured to perform dedicated tasks. For example, memory 230 may include a program 236 that performs the functions of computing system 200, or program 236 could comprise multiple programs. Additionally, processor 210 may execute one or more programs located remotely from computing system 200. For example, FSP system 130, merchant system 120, or user device 112, may, via computing system 200 (or variants thereof), access one or more remote programs that, when executed, perform functions related to certain disclosed embodiments. Processor 210 may further execute one or more programs located in database 240. In some embodiments, programs 236 may be stored in an external storage device, such as a cloud server located outside of computing system 200, and processor 210 may execute programs 236 remotely.

Programs executed by processor 210 may cause processor 210 to execute one or more processes related to financial services provided to users including, but not limited to, processing credit and debit card transactions, checking transactions, fund deposits and withdrawals, transferring money between financial accounts, lending loans, processing payments for credit card and loan accounts, and allocating transactions among a plurality of entities or accounts according to the disclosed embodiments.

Memory 230 may also store data that may reflect any type of information in any format that the system may use to perform operations consistent with the disclosed embodiments. Memory 230 may store instructions to enable processor 210 to execute one or more applications, such as server applications, a transaction allocation application, network communication processes, and any other type of application or software. Alternatively, the instructions, application programs, etc., may be stored in an external storage (not shown) in communication with computing system 200 via network 140 or any other suitable network. Memory 230 may be a volatile or non-volatile, magnetic, semiconductor, tape, optical, removable, non-removable, or other type of storage device or tangible (i.e., non-transitory) computer-readable medium.

Memory 230 may include transaction data 232. Transaction data 232 may include information related to purchase or payment transactions initiated by user 110. For example, transaction data may include a user identifier and a purchase price or payment amount and any other relevant transaction or merchant specific information. The user identifier may be a credit or debit card number, an account number, or another means for identifying the user initiating the purchase transaction. The purchase price may include a number representing the total sale price of the purchase transaction and/or may include a list of the various items purchased from the merchant or a category of items purchased. In other embodiments, a payment amount may include a sum of the transaction amount and other general information related to the payment including the name of the recipient, time and date of payment, and reason for payment etc.

In some embodiments, merchant system 120 may collect, generate, and provide transaction data relating to purchase transactions involving a user to FSP system 130. In some embodiments, merchant system 120 may further provide additional information to FSP system 130 including product or service data (e.g., SKU data) and other data such as a geographical location of a merchant and any other data relating to purchase transactions involving a user. Merchant system 120 may provide this information to FSP system 130 via network 140. Alternatively, transaction data 232 may be stored in database 240 or in an external storage (not shown) in communication with computing system 200 via network 140 or any other suitable network.

Memory 230 may further include client data 234, which may include information about particular clients of the financial service provider. For example, client data 234 may include client account information, debit or credit card information, history of purchase or payment transactions, financial statements, and one or more transaction rules according to the disclosed embodiments. Client data 234 may include a data record associating a client account with one or more other accounts according to the one or more transaction rules. Client data 234 may further contain one or more user profiles corresponding to individual client accounts. In some embodiments, client data 234 may be stored in database 240 or in an external storage (not shown) in communication with computing system 200 via network 140 or any other suitable network.

Processor 210, upon execution of one or more programs 236, may perform the functionality of the disclosed embodiments for enabling allocation of a transaction among multiple accounts. In the disclosed embodiments, processor 210 may analyze transaction data 232 in reference to client data 234 to perform the disclosed functionality. For example, processor 210 may analyze transaction data to determine which client with information stored in client information 234 is initiating the purchase transaction. Additionally, processor 210 may analyze the transaction data 232 with respect to one or more transaction rules stored in association with client data 234 to determine whether the transaction may be allocated to another account. In some embodiments, processor 210 may analyze a client request with respect to transaction data 232 to allocate the transaction to one or more other accounts designated by the client. Processor 210 may associate received transaction data with corresponding client data to update client account information accordingly. Processor 210 may also access data records stored as client data 234 to determine client account information, debit or credit card information, history of purchase transactions, financial statements and/or one or more transaction rules associated with an account. Other programmable functions of processor 210 are described in greater detail below.

I/O devices 220 may be one or more devices configured to allow data to be received and/or transmitted by computing system 200. I/O devices 220 may include one or more digital and/or analog communication devices that allow computing system 200 to communicate with other machines and devices, such as other components of system 100 shown in FIG. 1. Computing system 200 may also include interface components for one or more input devices, such as one or more keyboards, mouse devices, and the like, which may enable computing system 200 to receive input from an operator of FSP system 130 (not shown).

Computing system 200 may also contain one or more database(s) 240. Alternatively, computing system 200 may be communicatively connected to one or more database(s) 240. Computing system 200 may be communicatively connected to database(s) 240 through network 140. Database 240 may include one or more memory devices that store information and are accessed and/or managed through computing system 200. By way of example, database(s) 240 may include Oracle™ databases, Sybase™ databases, or other relational databases or non-relational databases, such as Hadoop™ sequence files, MongoDB™, HBase™, or Cassandra™. Database 240 may include computing components (e.g., database management system, database server, etc.) configured to receive and process requests for data stored in memory devices of database(s) 240 and to provide data from database 240.

As discussed above, FSP system 130 may include at least one computing system 200. Further, although sometimes discussed here in relation to FSP system 130, it should be understood that variations of computing system 200 may be used by other components of system 100, including merchant system 120 and user device 112. Computing system 200 may be a single server or may be configured as a distributed computer system including multiple servers or computers that interoperate to perform one or more of the processes and functionalities associated with the disclosed embodiments.

In some aspects, merchant system 120 may include the same or similar configuration and/or components of computing system 200. Computing system 200 when implemented in merchant system 120 may include any hardware and/or software installed therein necessary for performing methods and processes of the disclosed embodiments, such as for example, the processing of a payment transaction.

Merchant system 120, implementing a computing system 200, may sell or otherwise accept payment for products and/or services via network 140. For example, user 110 may use a user device 112 to browse a webpage hosted or otherwise associated with merchant system 120 that runs on computing system 200, and may make a purchase of products or services offered by merchant 120 via the webpage. In other embodiments, user 110 may initiate a purchase at a brick and mortar establishment associated with a merchant, and merchant system 120 (via, e.g., computing system 200, which may be a point of sale terminal in some embodiments) may communicate with FSP system 130 over network 140 to authorize the purchase. In some embodiments, a user may use a bank card managed by a financial service provider to purchase products or services from a merchant. A computing system 200 implemented as part of merchant system 120 may facilitate the transmission and receipt of transaction information and authorization to and from FSP system 130.

The following processes are directed to various embodiments for allocating a transaction among a plurality of accounts and may be performed by various aspects and components of system 100 and computing system 200 as is apparent from the disclosure.

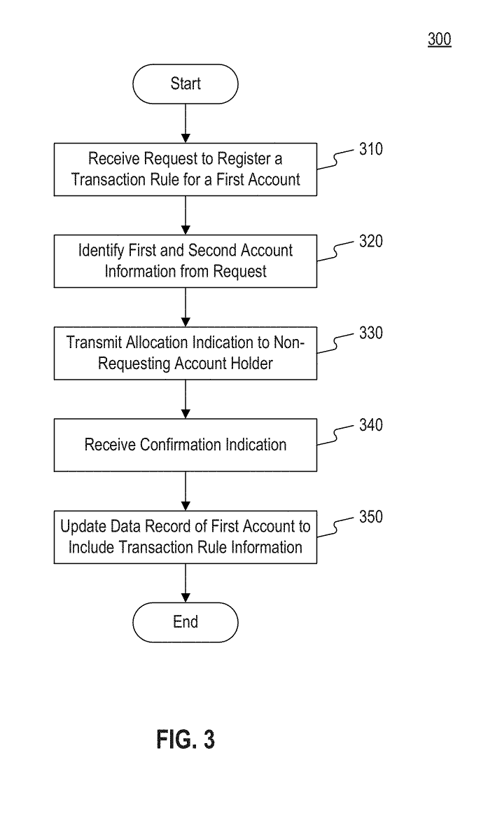

According to some embodiments, a user 110 with an account at a financial service provider may be enabled to designate, in advance, certain transactions to be allocated with another account (of the user or another entity) at a financial service provider. The two accounts may be with the same financial service provider or different financial service providers. According to this embodiment, user 110 may establish certain transaction rules associated with his client account according to a registration process 300, shown in FIG. 3.

FIG. 3 shows an exemplary registration process 300 enabling a user to designate certain transaction rules to be associated with a financial service account with a financial service provider. According to some embodiments, the operations of process 300 may be performed by aspects of a computing system 200 provided as part of a FSP system 130. For example, a processor 210 of computing system 200 may execute instructions encoded on a computer-readable medium storage device to perform the registration operations of process 300. FSP system 130 may also be configured to receive user requests, confirmations, and other input either directly or over network 140, for example. It is to be understood that one or more other underlying aspects of process 300 may be implemented by other components of system 100 (shown or not shown), including a user device 112 configured to transmit a request, for example, to FSP system 130.

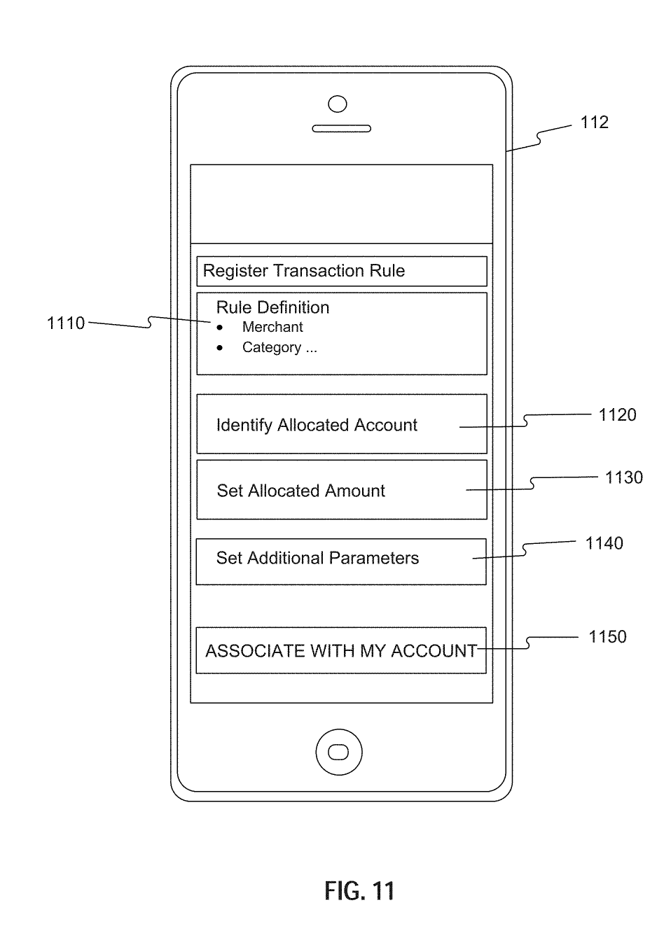

At operation 310, FSP system 130 may receive a request to register a transaction rule for a financial service account with a financial service provider. The request may be received from user device 112 operated by user 110 over network 140, or in any other suitable manner, including a request directly at a physical location of a financial service provider. In some embodiments, user 110 may enter the request using an application stored on user device 112. For example, the application may be stored on a smartphone as a native application associated with the financial service provider. An exemplary interface for such an application is shown in FIG. 11 and described with greater detail below.

As part of operation 310, the request received by FSP system 130 may include information identifying one or more client accounts, as well as information specifically identifying one or more transaction rules to be associated with a first account. In some embodiments, the request may include a modification to a pre-existing transaction rule. The request received as part of operation 310 may be received over multiple communications or transmissions between a user and the financial service provider. For example, in some embodiments, user 110 may perform multiple steps via an application on a smartphone (or other user device 112) to provide various information related to the request. In some embodiments, a smartphone application may include an interface that enables user 110 to select and/or enter certain information for defining one or more transaction rules to be associated with a first account according to the disclosed embodiments.

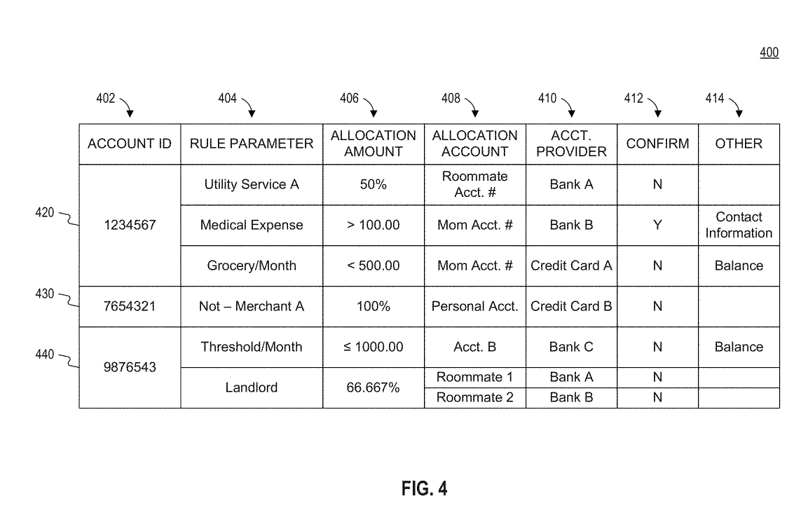

Examples of the one or more transaction rules are described in greater detail below with respect to FIG. 4. Generally though, a transaction rule may define the condition and manner of allocation between one or more accounts for a transaction according to any identifiable rule, such as relating to a particular transaction type, identity of merchant/recipient, or other characteristic of a transaction based on spending limits, etc. In some embodiments, a transaction rule may identify one or more transactions, the information of which is to be shared with another account. Thus, a transaction rule may define an allocation of liability between more than one account, or it may define the manner of sharing information of a transaction with another entity, without necessarily allocating liability of the transaction with the other entity.

As part of operation 320, FSP system 130 may identify first and second account information from the request. In some embodiments, the request may include a request to register a transaction rule for the requesting user's account. In another embodiment, the request may include a request to register a transaction rule for another user's account. Thus, in some embodiments, the first account includes a financial services account for which a transaction rule is to be applied, and the second account includes a financial services account that may share the transaction liability of a transaction made using the first account. The disclosed embodiments thus enable an account holder to either apply a transaction rule to his own account (linking a second account) or to another account linking his own account. It may be advantageous to enable a parent, for example, to request registration of a transaction rule for a child's independent account, rather than requiring a child to register the transaction rule on her own account herself.

The request received in operation 310 may include account information regarding more than one account. For example, a transaction rule may define an allocation of a transaction with two or more other accounts. In operations 310 and 320, account information for the first and second accounts may include any identifier associated with the plurality of accounts. For example, in some embodiments, a transaction rule may be registered to associate one or more accounts using an e-mail address or other identifier of the respective accounts. Thus, as part of operation 320, FSP system 130 may identify account information based on the received identifiers associated with the designated accounts.

In another embodiment, the requester need not transmit an account identifier of the non-requesting account holder. Instead, the request received in operation 310 may only include contact information of the non-requesting account holder such as a phone number or e-mail address or some other identifier. In this embodiment, the non-requesting account holder may be able to provide his own account information to supplement the request to register a transaction rule. Such account information may be received as part of a confirmation indication described with respect to operation 340 discussed further below.

As part of operation 330, FSP system 130 may transmit an allocation indication to one or more non-requesting account holders based on information identified in the request to register a transaction rule. The allocation indication may serve as a notification to the account holder and may also request the account holder to confirm or authorize the transaction rule. The allocation indication may be provided as part of a message transmitted to the non-requesting account holder. The message may be transmitted in any known manner, such as, for example, via a text message or e-mail. Additionally, the allocation indication may include an alert provided in an application stored on a user device of the non-requesting account holder. The allocation indication may also be provided to the non-requesting account holder in a billing statement or any other manner associated with the non-requesting account such as an alert when accessing the account via a website.

In some embodiments, the allocation indication transmitted in operation 330 includes any information relevant to the request to register a transaction rule. For example, the allocation indication may include information identifying the requesting account holder and any additional information related to or specifying the parameters of the transaction rule. As discussed further below with respect to FIG. 4, the transaction rule may include information regarding particular types of transactions or information related to transactions generally. The allocation indication may also include an indication as to which account the transaction rule is to be applied. For example, an allocation indication may include information specifying that the requester is requesting that certain transactions made using the requester's account are to be allocated to the non-requester's account. In another embodiment, the requester may be requesting that certain transactions made using the non-requester's account are to be allocated to the requester's account.

According to some embodiments, the allocation indication transmitted as part of operation 330 may be provided in a form that enables the recipient to confirm and/or modify the request to register the transaction rule. For example, in some embodiments, the allocation indication may be presented to the non-requesting account holder in the form of a text message or e-mail message. In this embodiment, the non-requesting account holder may be able to confirm and/or authorize the transaction rule by replying to the text message or e-mail. In other embodiments, the allocation indication may include an electronic link that may be accessed to confirm or modify the transaction rule.

As part of operation 340, FSP system 130 may receive a confirmation indication from the non-requesting account holder confirming or authorizing the requested transaction rule. The confirmation indication may be received in any known manner including, for example, as a reply to a text or e-mail message or as a selection submitted using an application or web interface or by accessing an electronic link included in the allocation indication. The confirmation indication may be received according to the nature of the allocation indication or may be transmitted in any alternative manner. Thus, in some embodiments, the non-requesting account holder may receive the allocation indication from operation 330 via text message, but may provide a confirmation indication via a web interface provided by the financial service provider.

In some embodiments, the confirmation indication received in operation 340 may include additional information related to the transaction rule including certain modifications or qualifiers for the requested transaction rule. In this embodiment, registration process 300 may include additional steps (not shown) for transmitting the modified transaction rule to the requesting account holder for confirmation or authorization. These steps may be repeated until a requested transaction rule is agreed upon by the requesting and non-requesting account holders.

In another embodiment, receipt of a confirmation indication as part of operation 340 may be optional. In this embodiment, a request to register a transaction rule may be automatically registered based on some predefined relationship between the account holders or based on the nature of the request itself. For example, when a request to register a transaction rule received in operation 310 includes a modification to an existing rule reducing the liability of the non-requesting account holder, a confirmation indication may not be necessary. Additionally, when the first and second accounts are associated with a single entity, step 340 may be omitted.

Once the parameters of a transaction rule are confirmed or authorized by the respective account holders, FSP system 130 may update a data record associated with the first account to include the registered transaction rule information (operation 350). An exemplary data record 400 according to the disclosed embodiments is shown in FIG. 4.

Data record 400, associating one or more transaction rules with a client account, may include a plurality of indexed fields or data items as shown in FIG. 4. For example, in some embodiments, data record 400 may include fields relating to an indexed account identifier 402, a rule parameter 404, an allocation amount 406, an allocation account 408, an account provider 410, a confirmation field 412 and a miscellaneous or “other” field 414. The indexed fields are exemplary. Some embodiments may include a data record with fewer or more fields. The disclosed embodiments are not limited to the particular arrangement or indexing of the plurality of fields shown in FIG. 4. Additionally, any manner of associating a financial service account with one or more transaction rules according to the disclosed embodiments may also be implemented. Data record 400 may be stored as client data 234 of computing system 200 or in a database accessible by computing system 200. Data record 400 may be a separate data record accessed as a look-up table, for example, or in other embodiments, aspects of data record 400 may be provided as part of individual client data 234 associated with individual accounts.

The data record 400 shown in FIG. 4 provides a number of examples of transaction rules contemplated by the present disclosure. The transaction rules illustrated are exemplary, and do not limit the scope of a transaction rule of the present disclosure. As an example, a first account 420 associated with an account identifier ‘1234567’ of an account with a financial service provider may be associated with one or more transaction rules. As shown, a first transaction rule may be registered with first account 420 pertaining to an allocation for transactions entered with a particular merchant “Utility Service A.” According to the transaction rule registered with first account 420, when a transaction is entered into with “Utility Service A” using any form of payment associated with first account 420, a transaction processing operation may determine that 50% of the transaction amount is to be allocated with a particular account, here designated as a “roommate account.” Thus, according to the illustrated transaction rule, 50% of the transaction amount paid to “Utility Service A” will be applied to first account 420 and the remaining 50% of the transaction amount will be applied to the identified roommate account.

Data record 400 may include any additional information useful for performing a transaction allocation according to the disclosed embodiments. The additional information may be regarding an account provider (field 410) of the allocation account (field 408). The additional information may include a bank name or routing number or any other information useful for allocating a particular transaction to the allocation account. Confirmation field 412 may include a flag indicating that confirmation or authorization may be required before completing an allocation transaction of the disclosed methods. Additionally, “other” field 414 may include any other information relevant to the performance of an exemplary method according to the disclosed embodiments.

As shown, a first account 420 may be associated with more than one transaction rule. For example, first account 420 may also include a transaction rule defined by a “Medical Expense” rule parameter. According to this embodiment, a transaction rule may designate that certain qualified medical expenses transacted using first account 420 may be allocated to a “mom account number.” In the example shown, any qualified medical expense greater than $100 may be allocated to the “mom account” indexed in the allocation account field 408. For example, a transaction made using first account 420 may be allocated between the account holder and the “mom account” based on the cost of the transaction. For any qualified medical expense less than $100, the transaction may be applied solely to first account 420. If the transaction amount exceeds a defined allocation amount 406, however, any additional expense over $100 may be allocated to the “mom account.” In some embodiments, according to the flag identifier in confirm field 412, upon determining that the transaction is to be allocated to the “mom account”, a user associated with the “mom account” may be required to confirm or authorize the transaction or the allocation before processing of the defined allocation is completed.

As another example, a transaction rule may be defined by a category of a transaction and a cumulative amount of a transaction for a given period of time, such as over a month, or a billing cycle. In the example shown in FIG. 4 pertaining to first account 420, a rule parameter may designate for allocation any transaction expenses related to a grocer category up to a defined limit over one month. For example, any transaction made using account 420 for qualified grocery expenses may be allocated to the identified “mom account” until the amount of qualified grocery expenses exceeds the defined limit of $500. Thus, any transaction made using first account 420 for groceries after the $500 limit within one month may subsequently be applied to first account 420. Data record 400 according to this example may include information identifying a remaining balance corresponding to the transaction rule. In this embodiment, the remaining balance may be indicated in the “other” field 414.

Data record 400 may include one or more transaction rules associated with more than one account. For example, a transaction rule associated with a second account 430 may also be included in data record 400. According to the illustrated example, second account 430 is associated with a transaction rule defined by the category of a transaction. In this example, any transaction made using second account 430 that is not made with “Merchant A” is to be allocated to a personal account associated with “Credit Card B.” Thus, in some embodiments, a user associated with second account 430 may use a payment card, for example, associated with second account 430 to make a number of transactions. In this embodiment, the payment card may be a credit card associated with a business account, for example, where the user is permitted to make purchases with “Merchant A” using the corporate account. Any purchases not with “Merchant A” are thus allocated to a personal account of the user.

Another example of a transaction rule is shown with respect to third account 440. As shown, one of the transaction rules associated with third account 440 is defined by a threshold spending amount per month. For example, according to the illustrated transaction rule, any transaction made using third account 440 may be allocated to account ‘B’ until the threshold spending amount is met for the month. Thus, once the aggregate amount of transactions made with third account 440 for a given month exceeds the $1000 threshold, any subsequent transactions using third account 440 shall be applied to third account 440. Data record 400 may include information identifying the remaining balance corresponding to the transaction rule in the “other” field 414, as shown. Such an embodiment may be useful, for example, to limit the spending on a particular account as a form of budgeting.

In yet another embodiment, a transaction rule may be defined to allocate a single transaction among more than one additional account. For example, as shown in one of the transaction rules associated with third account 440, a transaction made with “Landlord” may be allocated to an account associated with “roommate 1” and an account associated with “roommate 2.” According to the transaction rule shown, two-thirds of the transaction with the landlord is to be allocated to the accounts of “roommate 1” and “roommate 2.” The transaction rule may be defined such that the allocated portion of the transaction is to be split evenly among the two accounts, or according to any other predefined ratio.

The above disclosure provides concrete examples of only a subset of contemplated transaction rules. The gamut of potential transaction rules, therefore, may include other examples. For example, any transaction rule capable of definition may be implemented according to the present disclosure. Additionally, where one or more transaction rules associated with an account may conflict, certain transaction rules may be prioritized over others by one or more prioritization rules. For example, a user may designate specific rules to be applied before general rules, and spending limit rules to be prioritized over all other rules.

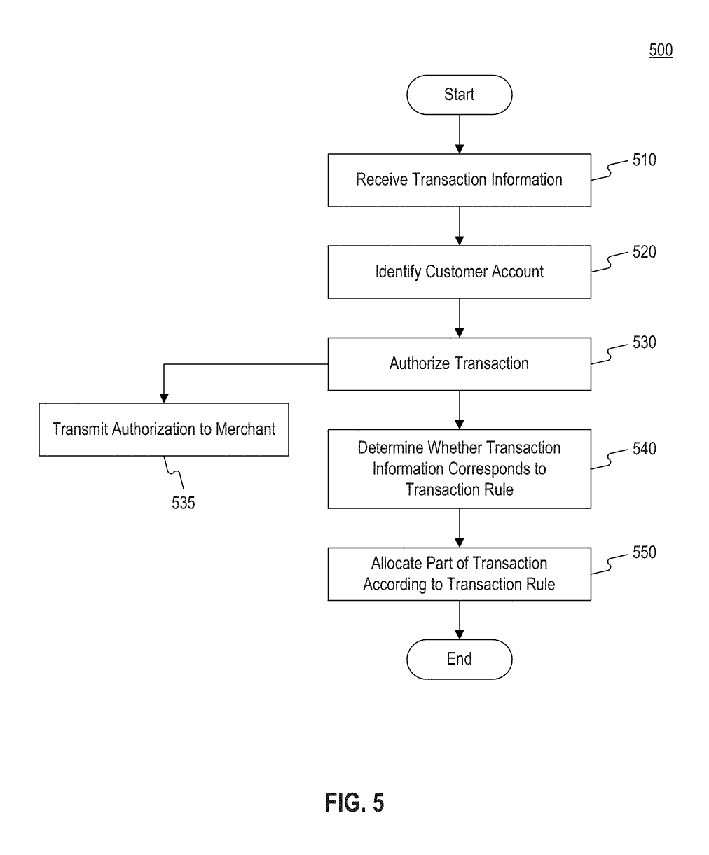

Once one or more transaction rules are registered or otherwise associated with an account of a financial service provider, the one or more transaction rules may direct the financial service provider, when processing a transaction, to allocate the transaction according to the applicable transaction rule. FIG. 5 illustrates an exemplary allocation process 500 for allocating part of a transaction according to a transaction rule.

Allocation process 500, according to some embodiments, may be performed by a financial service provider associated with FSP system 130. At operation 510, FSP system 130 may receive transaction information relating to one or more purchase or payment transactions. Transaction information may include, for example, a customer identifier associated with a customer account with the financial service provider used to make the purchase transaction, a purchase price indicating the amount of the purchase transaction, and a merchant identifier indicating the merchant from which the purchase transaction is being executed, and additional information related to the nature of the goods or services purchased. Merchant system 120 may collect or generate transaction information at the point of sale by processing a user's credit or debit card, for example, and transmit the transaction information to FSP system 130 as part of an authorization or pre-authorization process. This transaction information may be transmitted to FSP system 130 over network 140. I/O 220 of computing system 200 implemented in FSP system 130 may receive the transaction information. In some embodiments, FSP system 130 may store the received transaction information in memory 230 (e.g., as part transaction data 232). In the disclosed embodiments, a payment or purchase transaction may be initiated according to any known manner, and is not limited to processing credit or debit card information at a point of sale.

From the transaction information received in operation 510, FSP system 130 may identify a customer account used to execute the payment or purchase transaction (operation 520). The customer account may be identified, for example, by use of a customer identifier contained in the received transaction information, such as for example, a credit or debit card number or some other unique account identifier. FSP system 130 may then determine whether to authorize the transaction based on the received transaction information (operation 530). In some embodiments, FSP system 130 may access information associated with the customer account, stored as client data 234, to determine whether the transaction should be authorized based on the transaction amount and established spending limits for the account or a fraud indicator, for example. FSP system 130 may then transmit an authorization indication to merchant system 120 executing the transaction (operation 535). Upon receipt of the authorization indication, merchant system 120 may complete the payment or purchase transaction as it would any other transaction. The initial payment or purchase transaction amount may then be provided to the merchant as may be performed according to any other transaction.

After authorizing the payment or purchase transaction (operation 530) and thus indicating to a merchant to complete the transaction (operation 535), FSP system 130 may determine whether the received transaction information corresponds to a transaction rule associated with the customer account used to execute the transaction (operation 540). As part of operation 540, FSP system 130 may access a data record, such as data record 400 shown in FIG. 4, or other client data stored as client data 234 to first determine whether there are any transaction rules associated with the customer account. If the customer account is associated with one or more transaction rules, FSP system 130 may then compare the one or more transaction rules with the received transaction information to determine whether any of the transaction rules are applicable to the transaction.

For example, based on a transaction entered into with account 420 shown in FIG. 4, FSP system 130 may examine a merchant identifier or other information concerning the nature of the goods purchased to determine whether any of the rules defined in the rule parameter field 404 associated with account 420 are applicable to the transaction. If a merchant identifier received in the transaction information corresponds to “Utility Service A,” for example, FSP system 130 may determine that the transaction is to be processed according to the parameters of the transaction rule. As part of operation 540, FSP system 130 may perform additional operations to receive confirmation from the owner of the allocation account associated with the transaction rule, based on an indication provided in “confirm” field 412. Thus, in some embodiments, FSP system 130 may transmit a confirmation request to the allocation account owner, using contact information stored in “other” field 414, for example, requesting confirmation of the defined allocation before further processing the transaction.

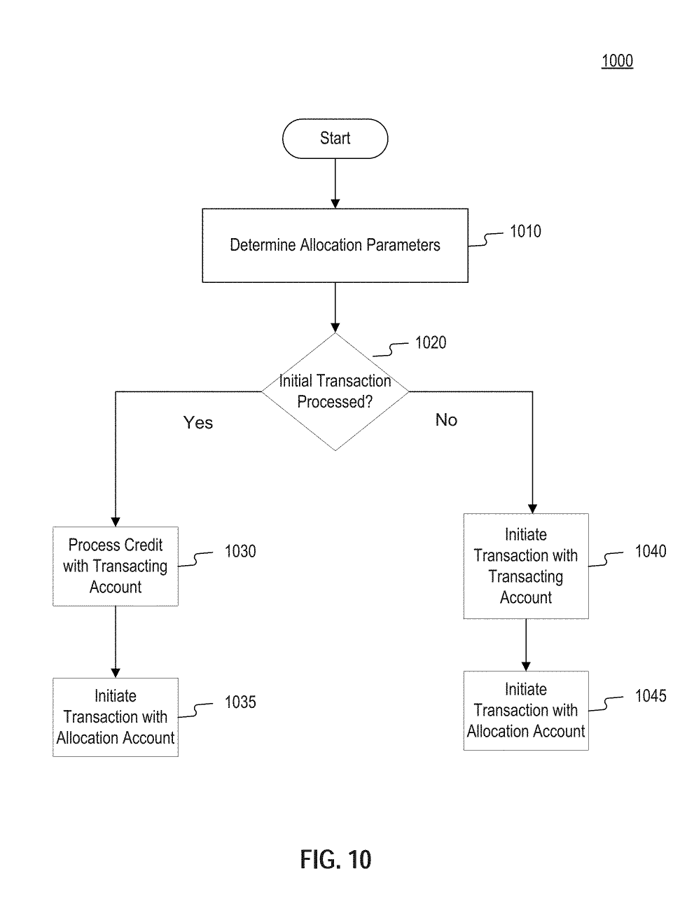

As part of operation 550, FSP system 130 may allocate part of the transaction according to the defined transaction rule applicable to the transaction. Continuing with the example of account 420, FSP system 130 may, as part of operation 550, examine the parameters of the applicable transaction rule to determine the nature of the allocation and other information of the second account to which a part of the transaction is to be allocated. Upon identifying second account information such as a “roommate account” and account provider information such as a routing number of “Bank A”, FSP system 130 may then process the transaction by allocating half of the transaction expense to account 420 and half of the expense to the “roommate account” using the identified account provider information. Additional discussion regarding processing of the allocated transaction is provided below with respect to FIG. 10.

As part of operation 550, FSP system 130 may also provide an indication to the allocated account holder notifying the account holder of the processed allocation. The notification may be transmitted by e-mail, text message, or other electronic message or alert associated with the allocated account.

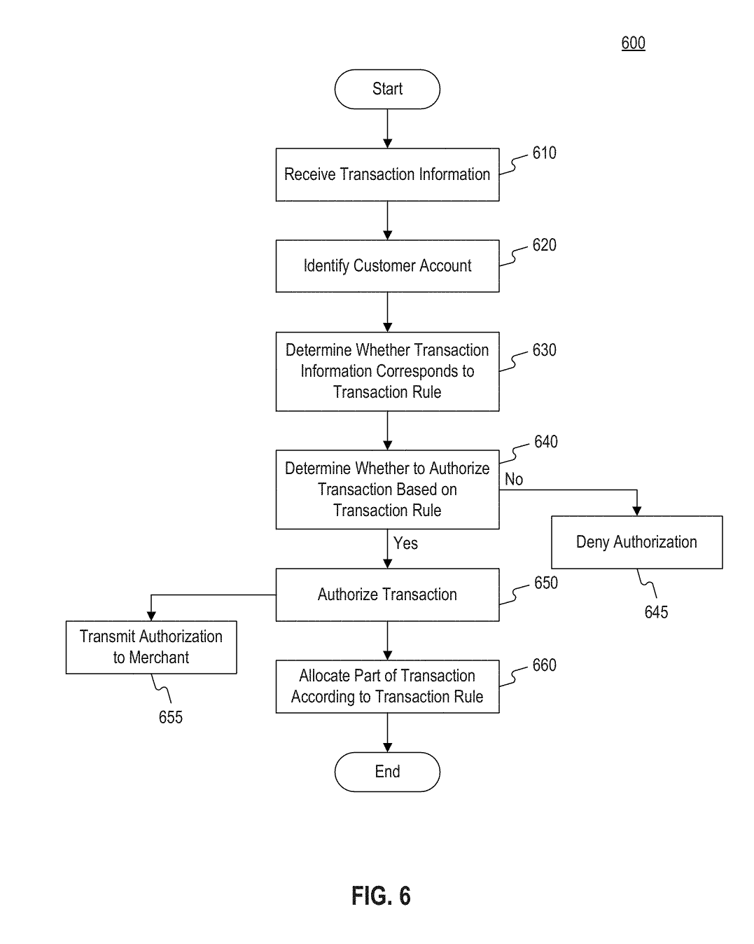

Allocation process 500 detailed above may authorize a particular transaction with a merchant based on customer account information of the account used to execute the transaction. In certain situations, however, it may be advantageous to authorize a transaction based on a transaction rule applicable to the transaction. For example, with respect to account 440 shown in FIG. 4, it may be beneficial to determine whether to authorize a transaction entered into with a “landlord” based on the ability of the “roommate 1” and “roommate 2” accounts to fulfill the transaction. This example is described in greater detail with respect to allocation process 600, shown in FIG. 6.

Operations 610 and 620 of allocation process 600 may be substantially the same as operations 510 and 520 described with respect to FIG. 5. Thus, FSP system 130 may receive transaction information corresponding to a transaction executed using a customer account of a financial service provider associated with FSP system 130. Upon identifying the customer account information from the received transaction information, FSP system 130 may then determine whether the received transaction information corresponds to a transaction rule associated with the customer account (630). FSP system 130 may perform operation 630 in the same manner described above regarding operation 540. Upon examining a data record, such as data record 400, or other information associated with the identified client account, FSP system 130 may determine that one or more transaction rules are applicable to the transaction. For example, with respect to account 440, when the received transaction information includes identifying information corresponding to a “landlord” as provided in “rule parameter” field 404, FSP system 130 may then determine that a transaction rule is applicable to the transaction.

FSP system 130 may then determine whether to authorize the transaction based on the applicable transaction rule (operation 640). For example, as part of operation 640, FSP system 130 may determine the respective allocation amounts for the associated accounts and determine whether the allocated amount to be applied to each account should be authorized. Returning to the example of account 440 shown in FIG. 4, FSP system 130 may determine that one-third of a transaction amount with the landlord is to be allocated to account 440, one-third of the transaction allocated to the account associated with “roommate 1,” and one-third of the transaction allocated to the account associated with “roommate 2.” FSP system 130 may then determine whether the allocated amounts should be authorized for each of the respective accounts. Authorization may be carried out based on known methods for pre-authorizing a transaction. As discussed in detail with respect to FIG. 10, the allocated transaction may be processed as if the allocated account entered into the initial transaction. In some embodiments, the initial transaction with the landlord may be authorized only if each of the transaction allocations is authorized. In another embodiment, FSP system 130 may determine to authorize the full initial transaction based on an authorization of any one of the allocated accounts for the full initial transaction amount. Other authorization rules are also contemplated by the present disclosure.

Based on a “Yes” determination of operation 640, FSP system 130 may authorize the transaction (operation 650). FSP system 130 may also transmit an authorization indication to a merchant signaling the merchant to complete the transaction (operation 655). Alternatively, based on a “No” determination of operation 640, FSP system 130 may deny authorization (operation 645) and the merchant may be notified accordingly. Once the determination is made to authorize the transaction, FSP system 130 may then allocate a part of the transaction to the one or more allocation accounts according to the transaction rule (operation 660). Additional discussion regarding processing of the allocated transaction is provided below with respect to FIG. 10.

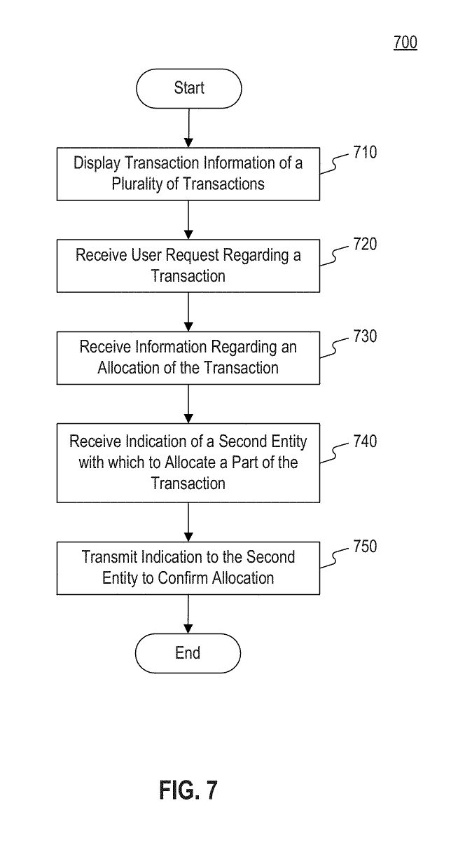

The above embodiments discuss methods for allocating a transaction based on a proactive embodiment in which a transaction rule is associated with a customer account in advance of executing a transaction. It may not always be feasible, however, to anticipate each transaction that a user may desire to allocate to another account. Thus, in some embodiments, an allocation method is provided for enabling a user to retroactively allocate a transaction to another account after the transaction has been initiated at a merchant, for example. This retroactive allocation method may be initiated by an allocation request process 700, shown in FIG. 7.

Request process 700, shown in FIG. 7, may be performed using a user device 112 configured with executable instructions for performing the process operations. As discussed above, user device 112 may include any of a number of devices configured to perform request process 700 such as a desktop computer, laptop, tablet, smartphone, multifunctional watch, pair of multifunctional glasses, tracking device, or any suitable device with computing capability. In some embodiments, the process operations may be performed in part by a financial service provide or an associated FSP system 130.

Request process 700 may be initiated by user 110 following a transaction associated with the user's customer account. For example, in some embodiments, user 110 may request a display of prior transaction information, such as using an application stored on the user's device 112, to specifically request allocation of a transaction. In another embodiment, user 110 may be alerted by a financial service provider, as to whether the user may want to allocate one or more transactions to another account. In this embodiment, the financial service provider may analyze past transaction history, past allocation history, and present transaction rules to determine whether an executed transaction may be one the user would like to allocate. Any additional information related to the transaction including a time or location or other crowdsourced information, for example, may be analyzed to determine whether to alert the user. The financial service provider may alert the user via a text message, e-mail, or an indication provided as part of an application stored on user device 112, or by any other indication means particular to user device 112, whether implemented as a laptop, smartphone, multifunctional watch, or other computing device. Receipt of the financial service provider's alert may then initiate request process 700.

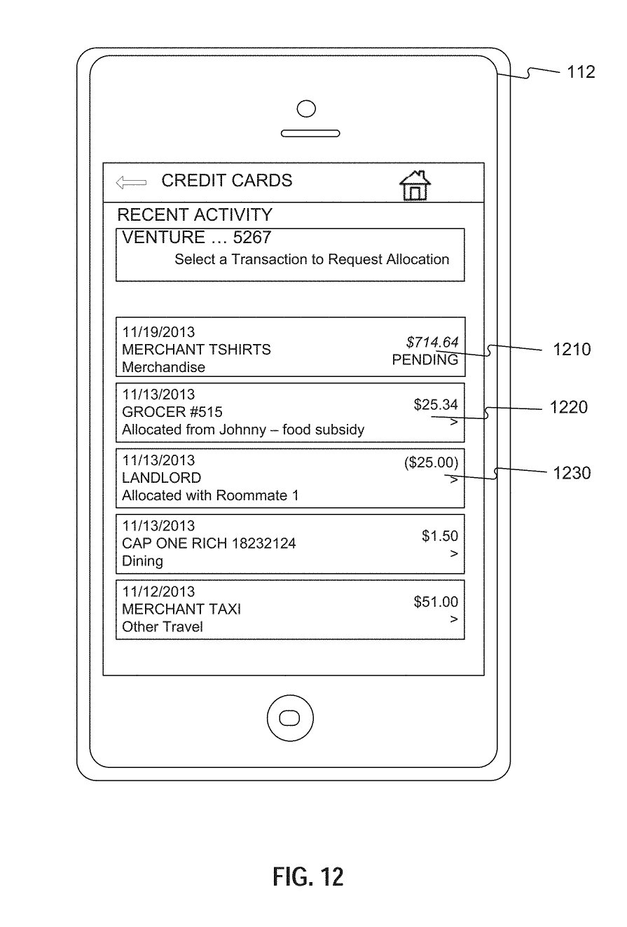

As shown in FIG. 7, allocation request process 700 may include a first operation 710 for displaying transaction information of a plurality of transactions. The plurality of transactions may include past transactions executed using one or more customer accounts associated with a financial service provider. The plurality of transactions may be displayed as part of an interface of a website or other computing application stored on user device 112. The website or other computing application may be configured to access and display customer account information associated with the customer account at a financial service provider, as is commonly known. The display or interface may be configured to receive a user selection of one or more of the displayed transactions. One exemplary interface is described below with respect to FIG. 12.

As part of operation 720, a user request may be received regarding one of the displayed transactions. The request may include an indication to allocate the selected transaction to one more other accounts. In addition to the request, additional information regarding the allocation may also be received (operation 730). The additional information may include the manner in which the transaction is to be allocated, including for example, a set amount or a percentage of the transaction amount. Other additional information may also include account information of one or more accounts with which to allocate the transaction and any other information that may be useful to execute the allocation. In some embodiments, an indication of a second entity with which to allocate a part of the selected transaction may also be received (operation 740). The indication received in operation 740 may include an identifier such as an e-mail address or a phone number or any other identifier to enable communication with the second entity with which the allocation is requested.

The information received as part of operations 720, 730 and 740 may be received over multiple communications or interactions between a user and the financial service provider via a website or other computing application interface. For example, in some embodiments, user 110 may perform multiple steps via an application on a smartphone (or other user device 112) to provide the various allocation information related to the request.

As part of operation 750, FSP system 130 may be configured to transmit an indication to the second entity with which the allocation is requested so the second entity can confirm the allocation. The indication may be transmitted according to any known manner associated with the nature of the identifying information received from the requester. For example, if the requester provides an e-mail address of the second entity, FSP system may transmit indication of the allocation request to the second entity using the received e-mail address. Operation 750 may be performed similarly to that described above with respect to operation 330 shown in FIG. 3.

In some embodiments, operation 750 may be optionally performed by FSP system 130. For example, in some embodiments, the request to allocate a transaction may be a request to allocate a transaction with another account associated with the requester. Indication of the allocation request may also be dispensed with based on one or more other relationships between the requesting entity and the second entity, or based on the nature of the request.

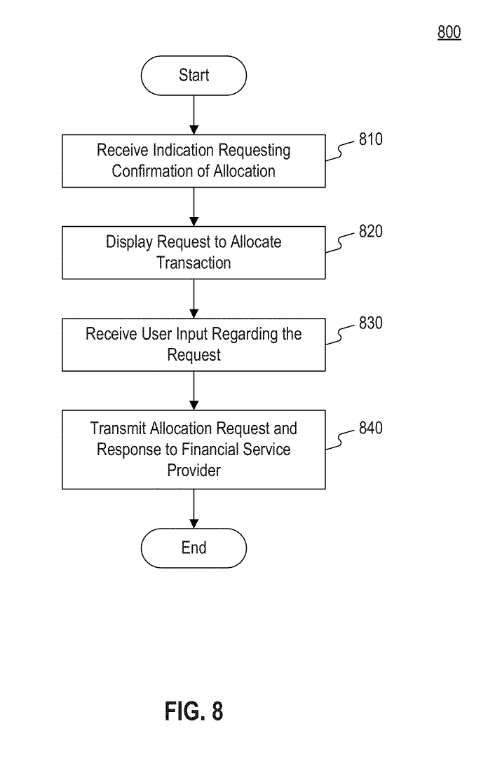

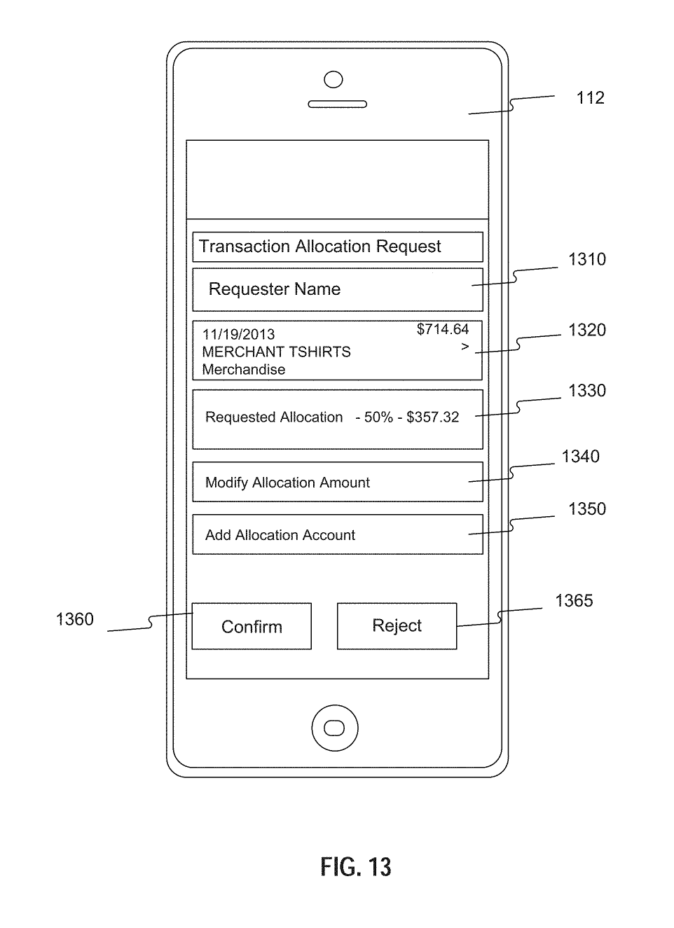

When operation 750 is performed as part of request process 700, the transmitted indication requesting confirmation of the allocation may be received by the second entity in operation 810, shown as part of confirmation process 800 in FIG. 8. Similar to request process 700, confirmation process 800 may be performed by a user device 112 associated with the second entity, with which an allocation has been requested. The indication received in operation 810, requesting allocation of a transaction, may be received in any known manner including via text message, e-mail, or as an indication provided as part of an application executable by the user device 112. The received indication may include an electronic link that may direct the second entity to a website or other interface for performing some of the other operations of confirmation process 800. An exemplary interface for confirmation process 800 is described in greater detail below with respect to FIG. 13.

As part of operation 820, the user device 112 may display the request to allocate a transaction. The displayed request may include a plurality of information useful for the second entity to determine whether to confirm the allocation request. For example, the displayed request may include information identifying the requester, as well as detailed information regarding the transaction to be allocated and the manner or apportionment of allocation.

The displayed request may be interactive and capable of receiving a user selection or user input regarding one or more aspects of the allocation request. For example, in some embodiments, the displayed allocation request may include a button or other selector for a user to indicate confirmation and acceptance (or rejection) of the allocation request as presented. In another embodiment, a user may be enabled to accept the allocation request by replying to the received indication via e-mail or text message, for example. The displayed allocation request may also include an input field or other selectable options to indicate a modification of the allocation request.

As part of operation 830, user device 112 may receive user input regarding the request. In some embodiments, as part of the user input received in operation 830, a user may provide account information with which to allocate part of the transaction. Thus, in this embodiment, the requester need not know specific account information for the allocated account. In another embodiment, user input may indicate an acceptance of the allocation parameters requested. In this embodiment, the confirmation or acceptance of the allocation request may then be transmitted to the financial service provider associated with the requester's account (operation 840). The confirmed allocation request may be transmitted to the financial service provider along with information regarding the confirmed allocation.

If the user input received as part of operation 830 includes a modification of the allocation request, a modified allocation request may be returned to the requester who then may receive the modified allocation request similar to operation 810. Operations 810, 820, and 830 may be repeated one or more times, until an allocation request is agreed upon by the parties. Once an agreement has been reached, the allocation request and the agreed upon details of the allocation request may be transmitted to the financial service provider of the requester's account (operation 840).

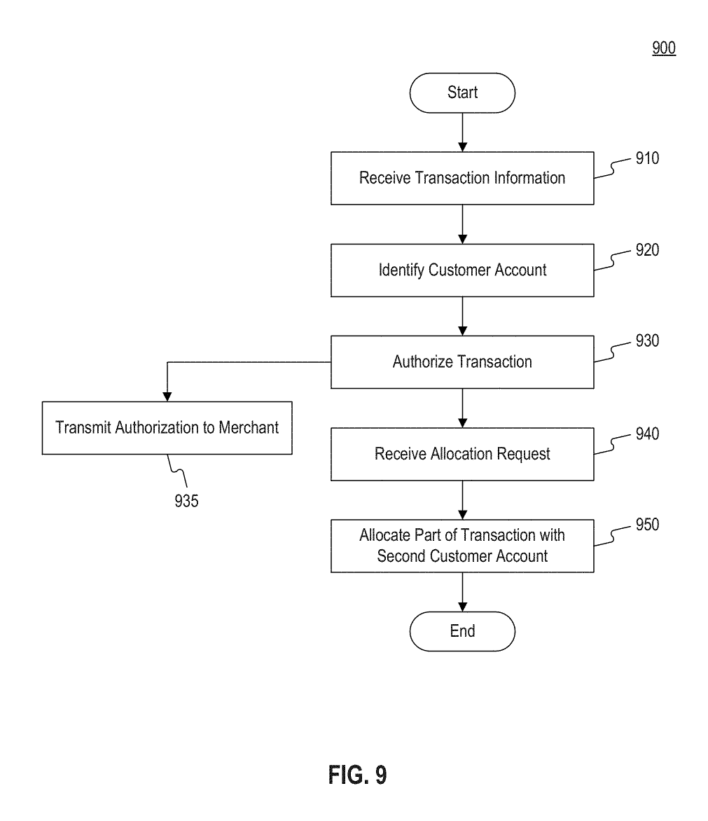

An exemplary allocation process 900 for processing an allocation request initiated after a transaction has been executed is shown and described with respect to FIG. 9.

Allocation process 900 may be performed by FSP system 130 associated with a financial service provider of a customer account used to execute a payment or purchase transaction. Similar to allocation process 500 shown in FIG. 5, FSP system 130 may receive transaction information (operation 910) corresponding to an executed transaction and identify a customer account associated with the transaction information (operation 920). Based on the received transaction information and the identified customer account, FSP system 130 may authorize the transaction (operation 930) and transmit an authorization indication to the merchant (operation 935) enabling the merchant to complete the transaction. Operations 910, 920, 930, and 935 may be performed substantially the same as operations 510, 520, 530, and 535 described with respect to allocation process 500 shown in FIG. 5. Allocation process 900, however, differs from allocation process 500 at least in that there is no transaction rule associated, in advance, with the transacting customer account that corresponds to the transaction information. The customer account may be associated with one or more transaction rules, but none of the transaction rules correspond to the received transaction information. Thus, allocation process 900 enables allocation of an executed transaction according to an allocation request received after the transaction is initiated.

As part of operation 940, FSP system 130 may receive an allocation request. The allocation request received by FSP system 130 may include the allocation request transmitted in operation 840 discussed above with respect to FIG. 8. Thus, according to some embodiments, the received allocation request includes confirmed or authorized allocation parameters previously agreed to by the parties. Additionally, the received allocation request may include any other information useful for completing the allocation including an identifier of the account that executed the transaction, as well as identifying information of a second account with which the transaction is to be allocated. Based on the information received in the allocation request, FSP system 130 may then allocate at least part of the identified transaction with a second account.

In some embodiments, allocation of the transaction in operation 950 may be performed while the initial transaction is in a process pending state. In other embodiments, the initial transaction may have already been processed. Additional details of an exemplary transaction allocation process 1000 are discussed with respect to FIG. 10 below.

Transaction allocation process 1000, shown in FIG. 10, may be performed by FSP system 130 to allocate an initial transaction amount among one more allocation accounts according to the disclosed embodiments. FSP system 130, as part of operation 1010, may determine any relevant allocation parameters needed to perform an allocation of an initial transaction. According to the disclosed embodiments, the relevant parameters may have been previously defined in a transaction rule associated with a customer account used to execute the initial transaction, as discussed with respect to FIG. 5 and FIG. 6, or alternatively, the relevant parameters may have been received in an allocation request, as discussed with respect to FIG. 9.

As part of operation 1020, FSP system 130 may then determine whether the initial transaction with the merchant has been processed with the transacting account. If the initial transaction has already been processed using the transacting account (“Yes”), then FSP system 130 may process a credit to be applied to the transacting account (operation 1030). FSP system 130 may determine the amount of credit based on the amount of the initial transaction and the determined allocation parameters. Thus, for example, depending on the nature of the allocation parameters, FSP system 130 may determine the amount to be allocated to the allocation account, and apply that amount to the transacting account as a credit. In some embodiments, the manner of processing the credit may depend on the manner of the initial transaction or the nature of the transacting account. For example, when the initial transaction is executed using a credit card associated with the transacting account, the credit process of operation 1030 may be performed according to any known manner for crediting part of the initial transaction.

FSP system 130, as part of operation 1035, may also initiate a transaction with an allocation account using any relevant information determined regarding the allocation account such as an account number, routing number, etc. FSP system 130 may initiate the transaction in any known manner according to the nature of the allocation account. For example, when the allocation account is associated with a credit card number, FSP system 130 may initiate a credit transaction using the credit card number associated with the allocation account. In some embodiments, the transaction may be initiated as any typical transaction executed using the credit card associated with the allocation account. Thus, according to some embodiments, the transaction initiated with the allocation account may be treated by the allocation account the same as a card-present transaction. In this embodiment, a user of the allocated account is thus able to enjoy any reward benefits or other incentives from the transaction allocation as if the allocation account was used in the initial transaction.

As part of operations 1030 and 1035 (as well as 1040 and 1045 discussed below), the disclosed embodiments may use any back-end method of transaction settlement and fund transfer, which may depend on the nature of the allocation account. For, example, funds may be sent using ACH, internal bank transfer, peer to peer transfer, or any other money transfer mechanism. Other funds transfer methods are also contemplated by this disclosure.

If the initial transaction has not yet been processed (operation 1020, “No”), FSP system 130 may initiate a transaction with the transacting account (operation 1040), as would be performed according to the manner of the initial transaction. Prior to operation 1040, however, FSP system 130 may determine the amount of the initial transaction to be applied to the transacting account based on the amount of the initial transaction and the determined allocation parameters, as similarly described with respect to operations 1030 and 1035. Thus, for example, when an allocation parameter indicates that the initial transaction is to be divided evenly among the transacting account and the allocation account, FSP system 130 may initiate a transaction with the transacting account for half the transaction amount, and initiate another transaction with the allocation account for the other half of the transaction amount. The transaction may be initiated with the allocation account according to the determined allocation parameters (operation 1045), as similarly described with respect to operation 1035.

User interaction in the above examples may be enabled using an interface of an application developed for download to mobile communications and computing devices, e.g., laptops, mobile computers, tablet computers, smart phones, multifunctional watches etc. The applications may be made available for download by the user either directly from the device, through a website, or through a dedicated application store. Exemplary interfaces illustrating aspects of the disclosed methods are shown in FIGS. 11-13.

FIG. 11 depicts an interface, according to some embodiments, that may be used to display a request to register a transaction rule, as similarly described with respect to operation 310 of registration process 300 shown in FIG. 3. The interface may be provided on a user device 112, which according to the illustrated embodiment, may be a smartphone. The interface shown may be part of a financial service provider application through which a user may access and modify various personal account information. An exemplary interface may include a first region 1110 from which a user may define the nature of a transaction rule to be registered and associated with an account. Region 1110 may be selectable to display additional options for defining a transaction rule. For example, a user may be enabled to select and define a transaction rule, such as one specific to a particular merchant or a category of purchases as similarly described with respect to the data record 400 shown in FIG. 4. An exemplary interface may also include additional regions for defining the various parameters of the transaction rule to be registered. For example, region 1120 may be accessed to identify the account with which to allocate the defined transaction. Region 1130 may be accessed to set the allocated amount or other rule for determining an allocated amount. Region 1140 may also be accessed to set any additional parameters to be associated with the transaction rule. Finally, an exemplary interface may include a selectable region 1150 for confirming the requested transaction rule to be associated with an account.

FIG. 12 illustrates another exemplary interface, according to some embodiments, that may be utilized to receive a selection of a transaction among a plurality of transactions for allocating with another entity, as similarly described with respect to allocation request process 700 shown in FIG. 7. According to this embodiment, an interface may be provided to display a plurality of recent transactions 1210, 1220 and 1230 executed using a particular financial service provider account. Additionally, the exemplary interface may indicate which of the recent transactions may have already been allocated with a second account or are part of an allocation from another account, as shown with respect to transactions 1220 and 1230. As shown, a user may be able to select a particular transaction from among the plurality of displayed transactions to initiate an allocation request. For example, a user may select transaction 1210 identified as a “MERCHANT TSHIRTS” transaction to allocate with one or more other accounts. In some embodiments, a user may be able to select either pending transactions or already processed transactions as shown. Upon selection of a particular transaction, a user may be provided with a follow-on interface for defining the parameters of the allocation request to be applied to the selected transaction.

FIG. 13 illustrates an exemplary interface for enabling user confirmation of an allocation request initiated by a requester, as similarly described above with respect to confirmation process 800 shown in FIG. 8. The exemplary interface may provide a first region 1310 identifying the requester of the transaction allocation. A second region 1320 may identify the particular transaction that the requester has requested to be allocated with the second entity. And a third region 1330 may include information defining the requested allocation of the transaction. The exemplary interface may also include accessible regions 1340 and 1350, which enable a user to modify the allocation request and specify account information for processing the requested allocation. Additionally, an exemplary interface may include a first selectable button 1360 enabling a user to confirm the received transaction allocation request, and a second selectable button 1365 enabling a user to reject the received allocation request.

The above disclosures associated with exemplary interfaces in FIGS. 11, 12, and 13 are presented by way of example only. The features and functionality of the disclosed embodiments are not limited or defined by the functionality suggested by the illustrated interfaces.

The above described processes may be implemented as a computer program or application or as a plug-in module or sub component of another application. Some of the described processes may be executed by a computing system 200 of a FSP system 130, merchant system 120, or user device 112. The described techniques may be varied and are not limited to the examples or descriptions provided.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, while a financial service provider has been described herein as the entity performing the transaction allocation methods, it is to be understood that consistent with disclosed embodiments, another entity may provide such services in conjunction with or separate from a financial service provider.

The claims are to be interpreted broadly based on the language employed in the claims and not limited to examples described in the present specification, which are non-exclusive. For example, aspects of the disclosed embodiments are described as being associated with data stored in memory, and one skilled in the art will appreciate that these aspects can be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

1-20. (canceled)

21. A method for allocating a transaction between multiple accounts, the method comprising:
acquiring, via a communication network, electronic data representative of transaction information relating to a first transaction executed by a first entity;
displaying, on a first device associated with the first entity, the transaction information;
acquiring, via the communication network, electronic data representative of a first allocation information associated with the transaction information;
determine, via one or more processors, a second entity to which to allocate a first part of the first transaction; and
transmitting, to a second device associated with the second entity via the communication network, electronic data representative of an allocation request, the allocation request comprising the first allocation information.

22. The method of claim 21, wherein the transaction information is selected based on analyzing past transaction history, past allocation history, or a present transaction rule.

23. The method of claim 21, further comprising receiving, at the first device via the communication network, an alert from a financial service provider, the alert comprising the transaction information.

24. The method of claim 21, further comprising:
receiving a user request via a user interacting with the alert; and
in response to receiving the user request:
acquiring, via the communication network, the transaction information.

25. The method of claim 21, further comprising:
receiving, from the second device via the communication network, electronic data representative of an modification request to modify the first allocation information, the modification request comprising second allocation information; and
displaying, on the first device, the modification request.

26. The method of claim 25, further comprising:
acquiring, via a user interaction with the displayed information on the first device, a response to the modification request; and
transmitting, to the second device via the communication network, the response to the second entity.

27. The method of claim 21, wherein the allocation request is transmitted via at least one of an e-mail, a text message, an alert, or an electronic link.

28. A method for confirming a transaction with multiple accounts, the method comprising:
acquiring, from a first device associated with a first entity via a communication network, electronic data representative of an allocation request to allocate a first transaction, the allocation request comprising first allocation information;
displaying, on a second device associated with a second entity, information representative of the allocation request;
acquiring, via the second device, electronic user input regarding the allocation request; and
transmitting, to the first device via the communication network, electronic data representative of a first allocation response to a financial service provider, the first allocation response comprising the acquired user input.

29. The method of claim 28, wherein the allocation request is acquired via at least one of an e-mail, a text message, an alert, or an electronic link.

30. The method of claim 28, wherein the displayed information comprises information identifying the first entity.

31. The method of claim 28, wherein the displayed information comprises a user request.

32. The method of claim 28, wherein the user input comprises account information, the account information comprising an indication of where to allocate the first transaction.

33. The method of claim 32, wherein the allocation response further comprises the account information.

34. The method of claim 28, further comprising sending, to the first device via a communication network, electronic data representative of a modification request to modify the first allocation information, the modification request comprising a request for user input, and the user input comprising the second allocation information.

35. The method of claim 34, further comprising:
receiving, from the first device via a communication network, a response to the modification request;
displaying, on the second device, information representative of the response to the modification request;
acquiring, via the second device, user input regarding the response to the modification request; and
transmitting, to the first device via the communication network, electronic data representative of a second allocation response to a financial service provider, the second allocation response comprising the acquired user input.

36. A computing device for requesting a transaction with multiple accounts, the computing device comprising:
at least one memory storing instructions; and
at least one processor configured to execute instructions to:
acquire, via a communication network, transaction information relating to a first transaction;
display information representative of the transaction information;
acquire a user request regarding the first transaction, the user request comprising:
first allocation information associated with the transaction information; and
an indication of a second entity to which a first part of the first transaction is to be allocated; and
transmit, to a device associated with the second entity via the communication network, an allocation request to the second entity, the allocation request comprising the first allocation information.

37. The computing device of claim 36, wherein the transaction information is selected based on an analysis of at least one of a past transaction, a past allocation, or a transaction rule.

38. The computing device of claim 36, wherein the at least one processor is configured to receive an alert from a financial service provider, the alert comprising the transaction information.

39. The computing device of claim 36, wherein the at least one processor is configured to:
receive, from the device via the communication network, a modification request to modify the first allocation information, the modification request comprising the second allocation information; and
display the modification request.

40. The computing device of claim 39, wherein the at least one processor is configured to:
acquire a response to the modification request; and
transmit, to the device via the communication network, the response to the second entity.
